(19) United States
(12) Patent Application Publication
(10) Pub. No.: US 2013/0325528 A1
(43) Pub. Date: Dec. 5, 2013

(54) SYSTEM TO COMPARE MULTIPLE HIERARCHIES WHILE SWITCHING THE COMPARISON BASELINE

(71) Applicant: Abhijit Kakhandiki, San Jose, CA (US)

(72) Inventor: Abhijit Kakhandiki, San Jose, CA (US)

(73) Assignee: Oracle International Corporation, Redwood Shores, CA (US)

(21) Appl. No.: 13/482,124

(22) Filed: May 29, 2012

(51) Int. Cl. G06Q 10/00

(52) U.S. Cl. 705/7.11

(57) ABSTRACT

A method of managing scenarios of a database includes creating one or more scenarios of various attributes of a portfolio, selecting a baseline scenario among the one or more scenarios, comparing the one or more scenarios, excluding the baseline scenario, to the baseline scenario, and displaying indicators for each scenario, each indicator representing the difference between an attribute of the baseline scenario and that of a scenario in which the indicator is being displayed.

### BACKGROUND

Various embodiment of the invention relate to database management for aiding in meeting a goal.

Information regarding product development is widely available, in raw form, and oftentimes provides a wide array of attributes regarding a particular product or product line. Such attributes or parameters include time lines for developing a product, forecast costs for building a product, projected revenues and profit, among many others. Tables of information are created to sort through and show this information in various forms. However, there is currently no suitable method of representing the raw data in a manner that would readily allow a user to analyze the effects of parameters and alterations of such parameters.

Accordingly, there is a need for a method of representing information in a manner suitable to strategize product development and/or business strategy.

### SUMMARY

Briefly, a method is disclosed for managing scenarios of a database. The method includes creating one or more scenarios of various attributes of a portfolio, selecting a baseline scenario among the one or more scenarios, comparing the one or more scenarios to the baseline scenario, and displaying indicators for each scenario, each indicator representing the difference between an attribute of the baseline scenario and that of a scenario in which the indicator is being displayed.

A further understanding of the nature and the advantages of particular embodiments disclosed herein may be realized by reference of the remaining portions of the specification and the attached drawings.

### BRIEF DESCRIPTION OF THE DRAWINGS

FIG. 1 shows a system employed in displaying scenarios, in accordance with an embodiment of the invention.

FIG. 2 shows a flow chart of the relevant steps performed by the processor the database system of FIG. 1, in accordance with a method of the invention.

FIG. 3 shows an exemplary portfolio management screen shot, generated by performing the steps of FIG. 2.

### DETAILED DESCRIPTION OF EMBODIMENTS

Particular embodiments and methods of the invention create and manage scenarios by creating one or more scenarios of various attributes of a portfolio, selecting a baseline scenario among the one or more scenarios, comparing the one or more scenarios, excluding the baseline scenario, to the baseline scenario, and displaying indicators for each scenario, each indicator representing the difference between an attribute of the baseline scenario and that of a scenario in which the indicator is being displayed.

The following description describes a database system for displaying scenarios and selecting a baseline scenario among the scenarios. Then, the use of the baseline scenario relative to the remaining scenarios is discussed.

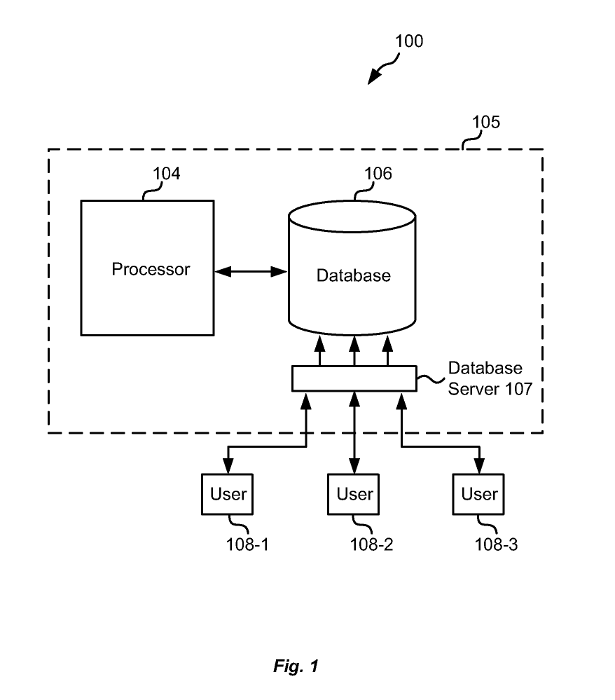

Referring now to FIG. 1, a system 100 is shown for displaying scenarios. The system 100 is shown to include a database system 105 and one or more users 108. The database system 105 is show to include database 106, a processor 104, and a database server 107.

The database server 107 is configured to receive and process information for database 106. The processor 104, which may include one or more processors, is shown to communicate with the database 106. While not shown, the users 108 may communicate with the processor 104. In the embodiment of FIG. 1, the users are shown to communicate with the database system 105 through the database server 107. The database system 105 may be any database system and a person of skill in the art will appreciate other components and variations of the database system 105.

Users 108 send and receive information to be performed in the database 106. The operations include reading data in database 106, writing data to database 106, updating data in database 106, and the like. In some embodiments, a user 108 communicates information regarding a product, a product line, or product strategy to the database 106 and the database 106 stores and manages information useful the user 108 in this regard.

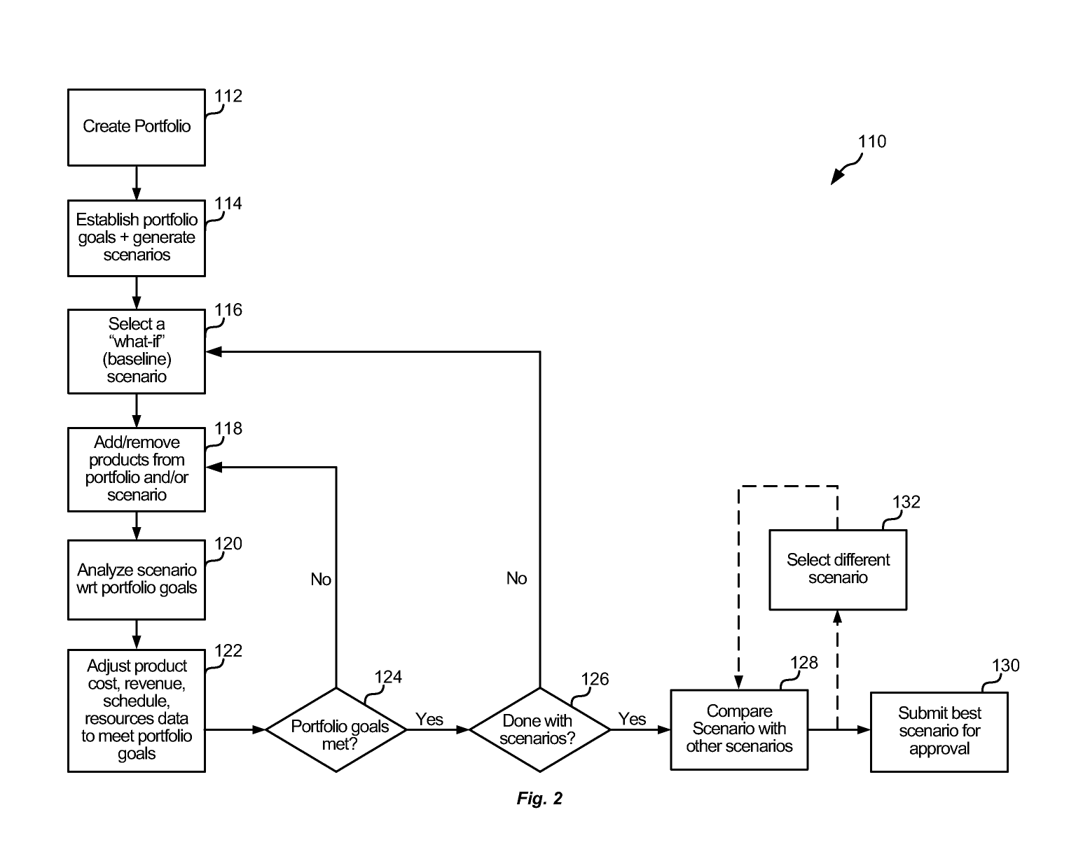

FIG. 2 shows a flow chart of the relevant steps performed by the processor the database system of FIG. 1, in accordance with a method of the invention. The processor 104 executes the following steps to the data stored in the database 108 and the database 108 manages the information stored therein in the manner disclosed below. It is understood that while the flow chart of FIG. 2 shows steps performed in determining product strategy, that other applications are contemplated.

The steps 110 of the flow chart of FIG. 2 show an exemplary method for developing and comparing scenarios of a given portfolio. In order to make sure that a company's portfolio of products follows it's business strategy, the portfolio team needs to create several ‘what-if’ scenarios to model the effect of choosing alternate product mixes.

Starting at step 112, a portfolio is created based on goal to be accomplished. Examples of such a goal include, but are not limited to, product strategy, financial strategy, and information technology and services strategy and any situation where a user needs to evaluate strategy satisfaction by modeling alternate mixes.

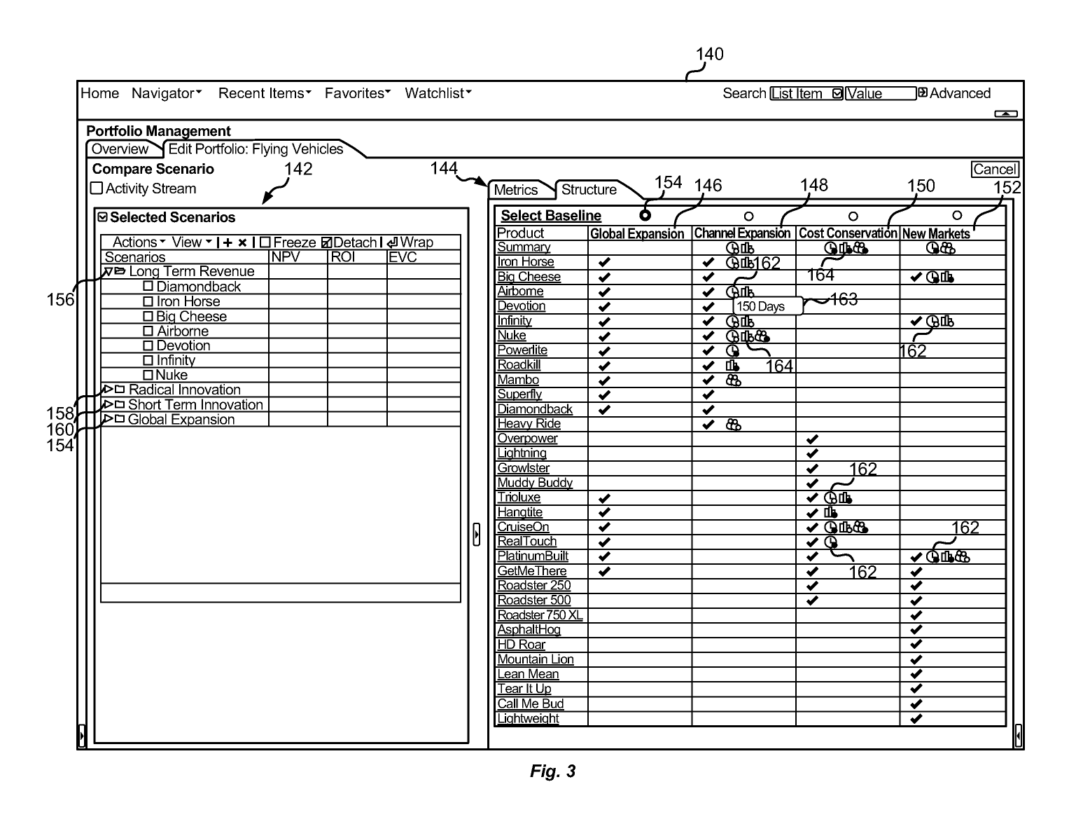

Next, at step 114, goals of the portfolio are established, which may be done at step 112 when creating the portfolio, and scenarios are generated. A “scenario” is generally created from a set of raw data, in the database 106, of various types of information, which are referred to throughout this document, as “parameters” or “attributes”. Exemplary attributes, in product strategy portfolio, include cost for developing a product, forecast revenues of the product, time line of development of the product, projected headcount for developing the produce, and so on. In the foregoing example, the scenario is likely to include multiple products. Examples of scenarios are presented with respect to an exemplary screen shot in FIG. 3.

Alternatively, a portfolio itself includes portfolios and/or portfolios within portfolios. For example, an enterprise portfolio might include a few business unit portfolios, each of which might include several product line portfolios.

After step 114, the process of FIG. 2 is shown to continue to step 116 where a baseline scenario is selected. A “baseline” scenario is analogous to a “what-if” scenario with this type of scenario setting the basis to which all remaining scenarios are compared. A baseline scenario therefore normalizes all remaining scenarios. Advantageously, the user 108 of FIG. 1 can manually change the identification of a baseline scenario thereby allowing for comprehensive analysis of the portfolio. In an embodiment, the user can change the baseline scenario on-the-fly or in real-time.

Next, at step 118, a product, within at least one of the scenarios generated at step 114, is selectably added or removed from the portfolio and/or scenario, according to the user 108's preference. Subsequently, at step 120, the scenario is analyzed by the user with respect to the portfolio goals. For example, the user 108 might be attempting to develop a roadmap best suited for a given product strategy, such as first-to-market, in which case, headcount may be of notable attention. In this case, at step 120, the analysis is regarding timing of the development of the product to be developed (prototype) and whether or not a targeted time-to-market is met. In this regard, adjustments may need to be made.

Next, at step 122, adjustment is made of the attributes of the product, such as cost, revenue, schedule, resources data, and the like, to meet the goal of the portfolio. Next, at 124, a determination is made as to whether or not, the portfolio goal is met and if not, the process goes back to step 118 and repeats until the portfolio goal is met at 124, otherwise, the process continues on to 126.

At 126, a determination is made as to whether or not the process of generating scenarios is complete and if so, step 128 is performed, otherwise, the process returns to step 116 and proceeds from there until the scenarios are determined to be complete at 126.

At step 128, the baseline scenario is compared with all remaining scenarios and the latter are normalized accordingly. Optionally, after step 128, at step 132, a different baseline scenario is selected by the user 108, followed by the step 128 being performed. After step 128, at step 130, the best scenario is approved by the user 108, the results of which are also displayed. Accordingly, in one embodiment the system provides a way to compare multiple hierarchies to a comparison baseline and also to switch the baseline to obtain a new comparison. In some embodiments, a scenario is displayed for each product in the portfolio.

FIG. 3 shows an exemplary portfolio management screen shot, generated by performing the steps of FIG. 2. The portfolio management screen shot 140 is shown to include a Portfolio Management screen for comparing various scenarios of the portfolio.

The portfolio of FIG. 3 is one of product strategy with the desired goal being value of the product(s). Two primary product tables are displayed, the table 142 and the table 144. Each table shows scenarios, one of which is a common scenario, the Golden Expansion scenario 154. Each scenario includes one or more products.

The table 142 is shown to include the Long Term Revenue scenario 156, the Radical Innovation scenario 158, the Short Term Innovation scenario 160, in addition to the Global Expansion scenario 154. The table 144 is shown to include the Channel Expansion scenario 146, the Cost Conservation scenario 150, and the New Materials scenario 152, in addition to the Global Expansion scenario 154. The scenarios of the table 144 form the columns thereof whereas the scenarios of the table 142 form the rows thereof.

In table 142, the Long Term Revenue scenario 156 is shown, in its expanded form, to include various products with names such as “Diamondback”, “Iron Horse”, Big Cheese”, . . . The remaining scenarios of table 142 are not shown in their expanded form but typically include various products. The criteria for the selection of products of a given scenario are user-defined and typically depend on the goal(s) of the portfolio.

The rows of table 144 show the names of products and a “Summary”, which appears in the top row of table 144. The check mark appearing under the scenario columns, in some of the rows of the table 144, are indicative of the inclusion of the particular product in a given scenario. For example, the product “Iron Horse” is included in the Global Expansion scenario 146 and the Channel Expansion scenario 148 but not the Cost Conservation and the New Markets scenarios 150 and 152.

In some of the rows of table 144, certain icons, appearing next to a neighboring check mark, each denote a comparison between the scenario in which they appear and the baseline scenario. In the example of FIG. 3, the baseline scenario is the Global Expansion scenario 146, as shown by the filled circle at 154, which is in contrast to the void circles appearing above the remaining scenarios of the table 144. Accordingly, an attribute of a scenario is compared to that of the Global Expansion scenario 146 and an icon is shown to represent the result of such comparison. For example, the clock icons 162 each represent a difference between the time line for developing a product, within a given scenario, relative to the time line for developing the same product using the Global Expansion scenario 146. Such time line icons are indicated, for example, in the Channel Expansion scenario 148 for products Iron Horse, Airborne, Infinity, etc. Other types of icons represent other types of information, such as the financial icon 164 denoting cost and revenue differences. Yet other types of information that may be represented by an icon include but are not limited to price, release date, headcount, risk, and the like.

Hovering over the icons reveals more details regarding the result of the comparison. For example, the time line icon 162 for the product “Airborne”, when hovered over, causes text box 163 to appear to indicate a 150-day difference between the Channel Expansion scenario 148 and that of the Global Expansion scenario 154 for that the Airborne product. In other embodiments, other types of icons or indicators and other ways of showing differences from a baseline scenario are possible. For example, The icon itself can indicate whether, and to what extent, there are differences from the baseline scenario. The icon can be red or green to indicate, respectively, a greater or lesser value from the baseline. The amount of red or green can indicate the degree of difference. Other colors and visual mechanisms can be used. For example, a meter, bar, number, text or other notation, animation, highlight, font or style, etc. can be used to convey information about the value of an attribute corresponding to an icon relative to the baseline scenario.

The Summary row of table 144 shows the net result of a comparison of all rows of each scenario, which indicates various information, such as but not limited to whether a scenario overall has later launch dates, utilizes more resources, generates more revenue, and the like.

As shown in FIG. 3, the scenarios, including the baseline scenarios, and their respective parameters and products are selectively displayed by the system 100 of FIG. 1. In accordance with the information displayed in the table 144, useful information is readily apparent to the user 108, particularly with respect to the icons, such as the risk of meeting a time line under a particular scenario.

Although the description has been described with respect to particular embodiments thereof, these particular embodiments are merely illustrative, and not restrictive.

Any suitable programming language can be used to implement the routines of particular embodiments including C, C++, Java, assembly language, etc. Different programming techniques can be employed such as procedural or object oriented. The routines can execute on a single processing device or multiple processors. Although the steps, operations, or computations may be presented in a specific order, this order may be changed in different particular embodiments. In some particular embodiments, multiple steps shown as sequential in this specification can be performed at the same time.

Particular embodiments may be implemented in a computer-readable storage medium for use by or in connection with the instruction execution system, apparatus, system, or device. Particular embodiments can be implemented in the form of control logic in software or hardware or a combination of both. The control logic, when executed by one or more processors, may be operable to perform that which is described in particular embodiments.

Particular embodiments may be implemented by using a programmed general purpose digital computer, by using application specific integrated circuits, programmable logic devices, field programmable gate arrays, optical, chemical, biological, quantum or nanoengineered systems, components and mechanisms may be used. In general, the functions of particular embodiments can be achieved by any means as is known in the art. Distributed, networked systems, components, and/or circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope to implement a program or code that can be stored in a machine-readable medium to permit a computer to perform any of the methods described above.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

Thus, while particular embodiments have been described herein, latitudes of modification, various changes, and substitutions are intended in the foregoing disclosures, and it will be appreciated that in some instances some features of particular embodiments will be employed without a corresponding use of other features without departing from the scope and spirit as set forth. Therefore, many modifications may be made to adapt a particular situation or material to the essential scope and spirit.

1. A method, performed by one or more processors, of managing scenarios of a database comprising:
creating, in response to user input and using the one or more processors, a plurality of scenarios of various attributes of a portfolio;
responding, using the one or more processors, to user input to select one scenario in the plurality of scenarios as a baseline scenario;
responding, using the one or more processors, to user input to select products included in each scenario of the plurality of scenarios;
displaying, using the one or more processors, a table including a first column having rows indicating a product name and subsequent columns, with each subsequent column representing a scenario in the plurality of scenarios and including rows having graphical indicia indicating whether a product in the corresponding row of the first column is included in the scenario;
displaying, using the one or more processors, an icon indicating which represented scenario is the baseline scenario; and
displaying, using the one or more processors, an attribute icon in a selected row of a non-baseline scenario indicating a result of a comparison of a value of a selected attribute of a product in the selected row of the non-baseline scenario to the value of the selected attribute of the product in the baseline scenario.

2. The method of managing scenarios of claim 1 further including displaying, using the one or more processors, a summary row in all columns where an attribute icon displayed in the summary row indicates a net result of a comparison of all rows of each scenario to the baseline scenario.

3. The method of managing scenarios of claim 1 further including analyzing, using the one or more processors, the one or more scenarios with respect to a portfolio goal.

4. The method of managing scenarios of claim 3 further including adjusting, using the one or more processors, attributes relating to products to meet the portfolio goal.

5. The method of managing scenarios of claim 1 wherein the portfolio goal is a goal of a portfolio that includes at least another portfolio.

6. The method of managing scenarios of claim 1 further including repeating, using the one or more processors, the selection of a baseline scenario and the comparison thereof until a portfolio goal is met.

7. The method of managing scenarios of claim 1 further including excluding, using the one or more processors, the baseline scenario from the comparison of the one or more scenarios with the baseline scenario.

8. The method of managing scenarios of claim 1 further including, displaying, using the one or more processors and in response to user input in proximity to an icon, a magnitude of the result of the comparison indicated by the icon.

9. The method of managing scenarios of claim 1 further including altering, using the one or more processors, the characteristics of an icon to provide information relating to the result of a comparison.

10. An apparatus comprising:
one or more processors; and
logic encoded in one or more non-transitory tangible media for execution by the one or more processors and when executed operable to perform the acts of:
creating, in response to user input, a plurality of scenarios of various attributes of a portfolio;
responding to user input to select one scenario in the plurality of scenarios as a baseline scenario;
responding to user input to select products included in each scenario of the plurality of scenarios;
displaying a table including a first column having rows indicating a product name and subsequent columns, with each subsequent column representing a scenario in the plurality of scenarios and including rows having graphical indicia indicating whether a product in the corresponding row of the first column is included in the scenario;
displaying an icon indicating which represented scenario is the baseline scenario; and
displaying an attribute icon in a selected row of a non-baseline scenario indicating a result of a comparison of a value of a selected attribute of a product in the selected row of the non-baseline scenario to the value of the selected attribute of the product in the baseline scenario.

11. The apparatus of claim 10 wherein the logic when executed is further operable to perform the act of:
adding or removing products from one or more scenarios.

12. The apparatus of claim 10 wherein the logic when executed is further operable to perform the act of:
analyzing the one or more scenarios with respect to a portfolio goal.

13. The apparatus of claim 12 wherein the logic when executed is further operable to perform the act of:
adjusting attributes relating to products to meet the portfolio goal.

14. The apparatus of claim 12 wherein the logic when executed is further operable to perform the act of:
displaying a summary row in all columns where an attribute icon displayed in the summary row indicates a net result of a comparison of all rows of each scenario to the baseline scenario.

15. The apparatus of claim 10 wherein the portfolio goal is a goal of a portfolio that includes at least another portfolio.

16. The apparatus of claim 10 wherein the logic when executed is further operable to perform the act of:
repeating the selection of a baseline scenario and the comparison thereof until a portfolio goal is met.

17. The apparatus of claim 10 wherein the logic when executed is further operable to perform the act of:
excluding the baseline scenario from the comparison of the one or more scenarios with the baseline scenario.

18. The apparatus of claim 10 wherein the logic when executed is further operable to perform the act of:
displaying, in response to user input in proximity to an icon, a magnitude of the result of the comparison indicated by the icon.

19. The apparatus of claim 10 wherein the logic when executed is further operable to perform the act of: altering the characteristics of an icon to provide information relating to the result of a comparison.

20. A non-transitory computer readable medium comprising encoded logic for execution by the one or more processors to mange scenarios of a database, the logic when executed operable to perform the acts of:
creating, in response to user input, a plurality of scenarios of various attributes of a portfolio;
responding to user input to select one scenario in the plurality of scenarios as a baseline scenario;
responding to user input to select products included in each scenario of the plurality of scenarios;
displaying a table including a first column having rows indicating a product name and subsequent columns, with each subsequent column representing a scenario in the plurality of scenarios and including rows having graphical indicia indicating whether a product in the corresponding row of the first column is included in the scenario;
displaying an icon indicating which represented scenario is the baseline scenario; and
displaying an attribute icon in a selected row of a non-baseline scenario indicating a result of a comparison of a value of a selected attribute of a product in the selected row of the non-baseline scenario to the value of the selected attribute of the product in the baseline scenario.
